(19) United States
(12) Patent Application Publication
(10) Pub. No.: US 2010/0039503 A1
(43) Pub. Date: Feb. 18, 2010

(54) DISPLAY AND DISPLAY METHOD THEREOF

(75) Inventors: Yung-Lun Lin, Yilan County (TW); Ching-Sheng Cheng, Kaohsiung County (TW); Chih-Jen Hu, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: AU OPTRONICS CORPORATION, Hsinchu (TW)

(21) Appl. No.: 12/266,531

(22) Filed: Nov. 6, 2008

(30) Foreign Application Priority Data
Aug. 14, 2008 (TW) 97130981

(51) Int. Cl. H04N 13/04; H04N 5/202

(52) U.S. Cl. 348/51; 348/674; 348/E13.001; 348/E05.074

(57) ABSTRACT

A display and a display method thereof are provided. The display is used for displaying 2D and/or 3D video image. The display method includes displaying 2D video image according to a first gamma curve and displaying 3D video image according to a second gamma curve, wherein the gamma value of the first gamma curve is greater than the gamma value of the second gamma curve.

### CROSS-REFERENCE TO RELATED APPLICATION

This application claims the priority benefit of Taiwan application serial no. 97130981, filed on Aug. 14, 2008. The entirety of the above-mentioned patent application is hereby incorporated by reference herein and made a part of this specification.

### BACKGROUND OF THE INVENTION

1. Field of the Invention

The present invention relates to a 2D/3D display technology, and more particularly, to a display method which achieves that the luminance is uniform or has no difference when a 2D/3D liquid crystal display (LCD) displays 2D and 3D video images.

2. Description of the Related Art

Recently, the development of the liquid crystal display (LCD) is upgraded from the conventional 2D LCD to 2D/3D LCD so as to satisfy users' demand for watching real images. In general, the current 2D/3D LCD roughly can be classified as auto-stereoscopic 2D/3D LCD or stereoscopic 2D/3D LCD.

However, when either type of 2D/3D LCD displays 3D video image, the luminance of the 3D video image displayed on the 2D/3D LCD is lower than or far lower than the luminance of the 2D video image displayed on the 2D/3D LCD because the pixel resolution would be reduced to half. Accordingly, the phenomenon of non-uniform luminance or difference in luminance would be felt by users when the 2D/3D LCD switches from the 2D video image to the 3D video image or from the 3D video image to the 2D video image.

### SUMMARY OF THE INVENTION

The present invention is directed to a display method which achieves that the luminance is uniform or has no difference when a 2D/3D liquid crystal display (LCD) independently or simultaneously displays 2D video image and 3D video image.

The present invention provides a display method for a display. The display is used for displaying a 2D and/or a 3D video image. The display method includes displaying the 2D video image according to a first gamma curve; and displaying the 3D video image according to a second gamma curve, wherein a gamma value of the first gamma curve is greater than a gamma value of the second gamma curve.

The present invention also provides a display including a display module, a backlight module, a switching unit and a control unit. The backlight module is used for providing a backlight source to the display module; the switching unit is used for collocating with the backlight module to make the display module display a 2D and/or a 3D video image; and the control module is used for synchronously controlling the display module and the switching unit by a synchronization mechanism, and making the display module independently or simultaneously display the 2D and/or the 3D video image according to a first gamma curve and a second gamma curve, wherein a gamma value of the first gamma curve is greater than a gamma value of the second gamma curve.

The present invention provides two gamma curves with different gamma values to the display, so that the display displays 2D video image according to one of the two gamma curves with greater gamma value, and displays 3D video image according to another one of the two gamma curves with smaller gamma value. Accordingly, whenever the display switches from the 2D video image to the 3D video image, or from the 3D video image to the 2D video image, or even though simultaneously displays the 2D video image and the 3D video image on the same video image, the luminance of the 2D/3D video image felt by human eyes would be uniform or has no difference.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a system diagram of a display according to an embodiment of the present invention.

FIG. 2 is a diagram of a first gamma curve and a second gamma curve according to an embodiment of the present invention.

FIG. 3 is a flow chart of a display method for a display according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

The present invention achieves at least the purpose of displaying 2D/3D video images on the display where the luminance of the images is uniform or has no difference for viewers.

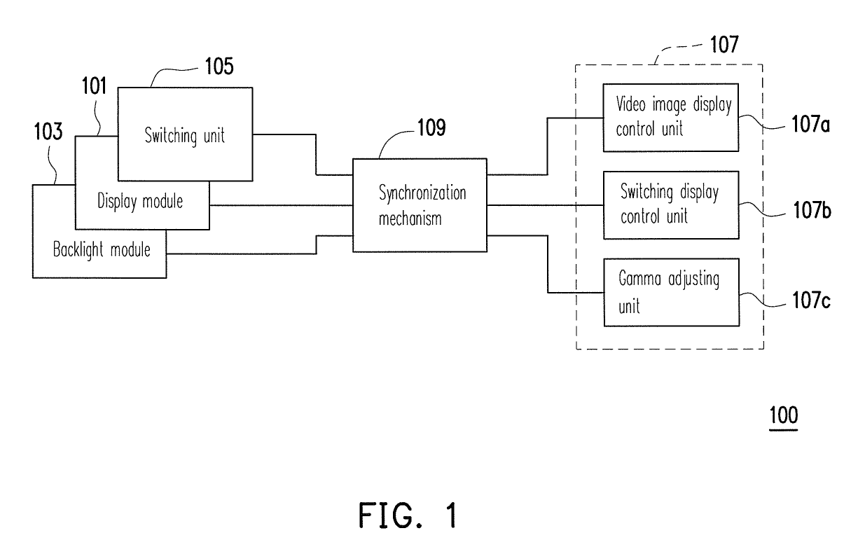

FIG. 1 is a system diagram of a display according to an embodiment of the present invention. Referring to FIG. 1, the display 100 of the present embodiment would be one of auto-stereoscopic 2D/3D liquid crystal display (LCD) or stereoscopic 2D/3D LCD, and includes a display module 101, a backlight module 103, a switching unit 105, a control module 107 and a synchronization mechanism 109. The backlight module 103 is used for providing a backlight source to the display module 103. The switching unit 105 is used for collocating with the display module 101 to make the display module 101 display a 2D and/or a 3D video image.

The control module 107 is used for synchronously controlling the display module 101 and the switching unit 105 by the synchronization mechanism 109, and making the display module 101 independently or simultaneously display the 2D and/or the 3D video image according to a first gamma curve and/or a second gamma curve. The gamma value of the first gamma curve (for example 2.0, but not limited thereto, and the gamma value of the first gamma curve would be changed by practical design requirement) is greater than the gamma value of the second gamma curve (for example 1.8, but not limited thereto also, and the gamma value of the second gamma curve would be changed by practical design requirement).

In the present embodiment, the control module 107 includes a video image display control unit 107a, a switching display control unit 107b, and a gamma adjusting unit 107c. The video image display control unit 107a is used for providing a 2D and/or a 3D video image data to the display module 101 by the synchronization mechanism 109. The switching display control unit 107b is used for controlling the switching unit 105 by the synchronization mechanism 109. The gamma adjusting unit 107c is used for providing the first gamma curve and the second gamma curve to the display module 101 by the synchronization mechanism 109. It should be noted that the synchronization mechanism 109 is capable of controlling the backlight module 103.

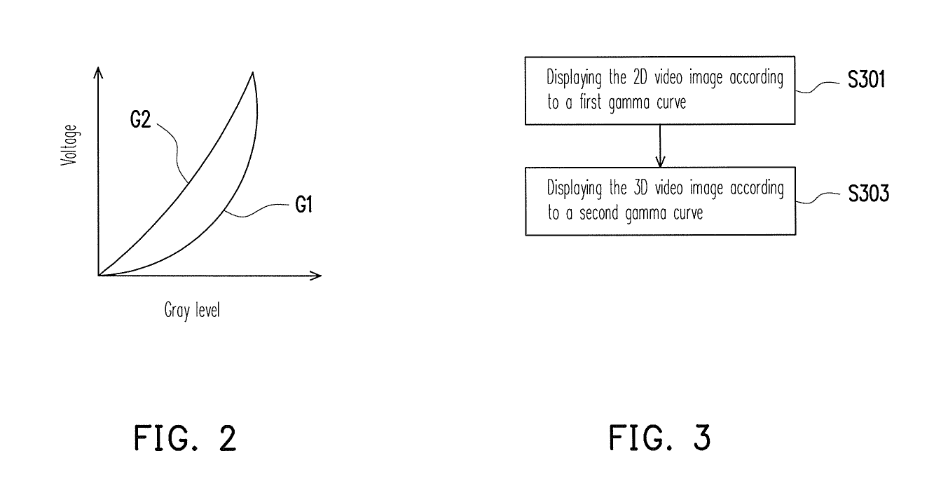

To be specific, when the display module 101 displays the 2D video image, the video image display control unit 107a would provide the 2D video image data to the display module 101 by the synchronization mechanism 109; the switching display control unit 107b would control the switching unit 105 by the synchronization mechanism 109 to make the switching unit 105 would not generate barriers; and the gamma adjusting unit 107c would provide the first gamma curve, such as the gamma curve G1 in FIG. 2, to the display module 101.

Accordingly, the display module 101 would convert the 2D video image data provided by the video image display control unit 107a to the 2D gray voltage according to the first gamma curve G1 provided by the gamma adjusting unit 107c, and transmit the 2D gray voltage to a plurality of pixel units arranged in matrix therein (not shown) so as to display the 2D video image.

In addition, when the display module 101 displays the 3D video image, the video image display control unit 107a would provide the 3D video image data (for example, right and left eyes video image data) to the display module 101 by the synchronization mechanism 109; the switching display control unit 107b would control the switching unit 105 by the synchronization mechanism 109 to make the switching unit 105 would generate barriers; and the gamma adjusting unit 107c would provide the second gamma curve, such as the gamma curve G2 in FIG. 2, to the display module 101.

Accordingly, the display module 101 would convert the 3D video image data provided by the video image display control unit 107a to the 3D gray voltage according to the second gamma curve G2 provided by the gamma adjusting unit 107c, and transmit the 3D gray voltage to a plurality of pixel units arranged in matrix therein (not shown) so as to display the 3D video image.

From the above, the present embodiment correspondingly provides two gamma curves G1 and G2 with different gamma values through the gamma adjusting unit 107c to the display module 101, so that the display module 101 displays 2D video image according to the gamma curve G1 with greater gamma value, and displays 3D video image according to the gamma curves G2 with smaller gamma value. Accordingly, whenever the display module 101 switches from the 2D video image to the 3D video image or from the 3D video image to the 2D video image, the luminance of the 2D/3D video image felt by human eyes would be uniform or has no difference.

Moreover, the present embodiment would collocate with the synchronization mechanism 109 to control the backlight module 103 so as to make the luminance of the 2D/3D video image displayed on the display module 101 would be further uniform or has further no difference except adjust the gamma curves.

In addition, when the display module 101 simultaneously displays the 2D video image and the 3D video image on the same video image (the video image simultaneously having the 2D video image and the 3D video image would be called as a multiple video image hereinafter), the gamma adjusting unit 107c would provide the first gamma curve G1 and the second gamma curve G2 at the same time to the display module 101, so as to make the display module 101 display the 2D video image within the multiple video image according to the first gamma curve G1, and display the 3D video image within the multiple video image according to the second gamma curve G2. Accordingly, even though when the display module 101 simultaneously displays the 2D video image and the 3D video image on the same video image, the luminance of the multiple video image felt by human eyes would be uniform or has no difference also.

According to the content disclosed in the above embodiment, a display method for a display is summarized below for those skilled in the art. FIG. 3 is a flow chart of a display method according to an embodiment of the present invention. Referring to FIG. 3, the display method of the present embodiment is adapted to any one auto-stereoscopic 2D/3D LCD or stereoscopic 2D/3D LCD, and the auto-stereoscopic 2D/3D LCD or stereoscopic 2D/3D LCD is used for displaying a 2D and/or a 3D video image.

The display method of the present embodiment includes the steps of displaying the 2D video image according to a first gamma curve (S301); and displaying the 3D video image according to a second gamma curve (S303). The gamma value of the first gamma curve (for example 2.0, but not limited thereto, and the gamma value of the first gamma curve would be changed by practical design requirement) is greater than the gamma value of the second gamma curve (for example 1.8, but not limited thereto also, and the gamma value of the second gamma curve would be changed by practical design requirement).

In the step S301, the 2D video image data must be provided to the display firstly, so that the display would convert the 2D video image data to the 2D gray voltage according to the first gamma curve, and transmit the 2D gray voltage to a plurality of pixel units within the display. Accordingly, the 2D video image would be displayed on the display.

In addition, in the step S303, the 3D video image data (for example, right and left eyes video image data) must be provided to the display firstly, so that the display would convert the 3D video image data to the 3D gray voltage according to the second gamma curve, and transmit the 3D gray voltage to a plurality of pixel units within the display. Accordingly, the 3D video image would be displayed on the display.

Since the display method of the present embodiment correspondingly provides two gamma curves with different gamma values to the display, so that the display displays 2D video image according to one of the two gamma curves with greater gamma value, and displays 3D video image according to another one of the two gamma curves with smaller gamma value. Accordingly, whenever the display switches from the 2D video image to the 3D video image or from the 3D video image to the 2D video image, the luminance of the 2D/3D video image felt by human eyes would be uniform or has no difference.

Besides, the display method of the present embodiment further includes the steps of simultaneously displaying the 2D video image and the 3D video image on the same video image according to the first gamma curve and the second gamma curve respectively (the video image simultaneously having the 2D video image and the 3 D video image would be called as a multiple video image hereinafter). The display displays the 2D video image within the multiple video image according to one of the two gamma curves with greater gamma value, and display the 3D video image within the multiple video image according to another one of the two gamma curves with smaller gamma value. Accordingly, even though when the display simultaneously displays the 2D video image and the 3D video image on the same video image, the luminance of the multiple video image felt by human eyes would be uniform or has no difference also.

In summary, the present invention provides two gamma curves with different gamma values to the display, so that the display displays 2D video image according to one of the two gamma curves with greater gamma value, and displays 3D video image according to another one of the two gamma curves with smaller gamma value. Accordingly, whenever the display switches from the 2D video image to the 3D video image, or from the 3D video image to the 2D video image, or even though simultaneously displays the 2D video image and the 3D video image on the same video image, the luminance of the 2D/3D video image felt by human eyes would be uniform or has no difference.

It will be apparent to those skilled in the art that various modifications and variations can be made to the present invention without departing from the scope or spirit thereof. In view of the foregoing, it is intended that the present invention cover modifications and variations of this invention provided they fall within the scope of the following claims and their equivalents.

What is claimed is:

1. A display method for a display, the display being used for displaying a two dimensional (2D) and/or a 3D video image, the display method comprising:
displaying the 2D video image according to a first gamma curve; and
displaying the 3D video image according to a second gamma curve,
wherein a gamma value of the first gamma curve is greater than a gamma value of the second gamma curve.

2. The display method according to claim 1, further comprising:
providing a 2D video image data; and
converting the 2D video image data to a 2D gray voltage according to the first gamma curve.

3. The display method according to claim 2, further comprising:
transmitting the 2D gray voltage to a plurality of pixel units of the display.

4. The display method according to claim 1, further comprising:
providing a 3D video image data; and
converting the 3D video image data to a 3D gray voltage according to the second gamma curve.

5. The display method according to claim 4, further comprising:
transmitting the 3D gray voltage to a plurality of pixel units of the display.

6. The display method according to claim 1, further comprising:
simultaneously displaying the 2D video image and the 3D video image on the same video image according to the first gamma curve and the second gamma curve respectively.

7. A display, comprising:
a display module;
a backlight module for providing a backlight source to the display module;
a switching unit for collocating with the backlight module to make the display module display a 2D and/or a 3D video image; and
a control module for synchronously controlling the display module and the switching unit by a synchronization mechanism, and making the display module independently or simultaneously display the 2D and/or the 3D video image according to a first gamma curve and a second gamma curve,
wherein a gamma value of the first gamma curve is greater than a gamma value of the second gamma curve.

8. The display according to claim 7, wherein the control module comprises:
a video image display control unit for providing a 2D and/or a 3D video image data to the display module by the synchronization mechanism;
a switching display control unit for controlling the switching unit by the synchronization mechanism; and
a gamma adjusting unit for providing the first gamma curve and the second gamma curve to the display module by the synchronization mechanism.

9. The display according to claim 7, wherein the display module displays the 2D video image according to the first gamma curve.

10. The display according to claim 7, wherein the display module displays the 3D video image according to the second gamma curve.

11. The display according to claim 7, wherein the display module simultaneously displays the 2D video image and the 3D video image on the same video image according to the first gamma curve and the second gamma curve, respectively.
